(19) United States
(12) Patent Application Publication
(10) Pub. No.: US 2026/0253115 A1
(43) Pub. Date: Aug. 27, 2026

(54) METHOD AND SYSTEM FOR PROVIDING OPTIONAL PLATFORM ALBUM-BASED SERVICE

(71) Applicant: WEVERSE COMPANY INC., Seongnam-si, Gyeonggi-do (KR)

(72) Inventors: Sang Il SIM, Seongnam-si, Gyeonggi-do (KR); Seung Hyun BANG, Yongin-si, Gyeonggi-do (KR); Min Hyuk BAEK, Namyangju-si, Gyeonggi-do (KR); Joo Won SOHN, Seoul (KR); Yu Kyung JANG, Suwon-si, Gyeonggi-do (KR)

(73) Assignee: WEVERSE COMPANY INC., Seongnam-si, Gyeonggi-do (KR)

(21) Appl. No.: 18/874,801

(22) PCT Filed: Jun. 8, 2023
(86) PCT No.: PCT/KR2023/007885

§ 371 Date: Dec. 13, 2024

(30) Foreign Application Priority Data
Jun. 14, 2022 (KR) 10-2022-0072094

(51) Int. Cl. G06Q 30/0601; G06Q 30/0201; G06Q 30/0283

(52) U.S. Cl. CPC G06Q 30/0621; G06Q 30/0201; G06Q 30/0283

(57) ABSTRACT

A method for providing an optional platform album-based service according to an embodiment of the present disclosure, in which a platform application executed by at least one processor of a terminal provides an optional platform album-based service, includes: providing an optional platform album purchase interface; determining included components of an optional platform album based on the provided purchase interface; performing a payment process according to the determined included components; performing a delivery process according to the determined included components; and providing sales authentication information about the optional platform album based on a unique number of the optional platform album and a delivery code acquired based on the performed delivery process.

### TECHNICAL FIELD

The present disclosure relates to a method for providing an optional platform album-based service and a system therefor. More specifically, the present disclosure relates to a method for providing a service based on an optional platform album capable of being purchased by selectively setting purchase options and a system therefor.

### BACKGROUND ART

Conventional transactions of content such as records or movies were conducted by storing files containing the content on storage media such as CDs or tapes, and trading the storage media offline.

Typically, these cultural content are provided with additional configurations (for example, digital content that may be activated upon purchase of the cultural content, album jackets, pictorials, and/or predetermine special benefits) in addition to CDs or tapes containing the content, with the aim of increasing purchaser satisfaction or sales volume.

Nowadays, by virtue of the rapid development of wireless communications and their equipment, most of the marketplaces for providing such cultural content have moved to online communications networks.

However, in the conventional online/offline cultural content purchasing method, it is common to sell ready-made products (for example, a predetermined artist's album) in a full-packaging state that includes both the main content and its additional configurations. Accordingly, there is an issue that purchasers inevitably have to purchase unnecessary configurations (for example, CDs or tapes).

This places the burden on purchasers to purchase the ready-made product, even at the cost of unnecessary expenses.

Depending on the situation, there are cases where a purchaser wants to purchase multiple specific configurations (for example, album jackets, pictorials, or predetermined special features) within the ready-made product. However, even in such cases, the purchaser needs to purchase the entire ready-made product in a fully packaged state that has presently been manufactured, which causes the inconvenience of duplicate purchases of unnecessary configurations.

In keeping with the current situation where various types of cultural content that have been recently sold in an analog manner are being digitized, the method of purchasing offline content is changing to online-based digital purchases such as mp3 files or internet streaming.

In addition, as devices for listening to music are moving away from analog playback devices such as conventional CD players and are now supported by various devices such as MP3 players, PMPs, and/or mobile phones based on MP3 files representing digital sound sources, the pattern of purchasing cultural content is rapidly shifting to an online-based one.

However, when the content is purchased online, an aggregation is often not easily reflected in the sales volume for the content, and thus has limitations in that the aggregation does not sufficiently serve as basic data used to determine the ranking of each content on certain music charts (for example, Gaon Chart).

Accordingly, there is an issue that although the sales volume of certain cultural content is actually very high, it is not properly reflected in chart aggregation or ranking, so an accurate ranking chart may not be provided, and its reliability is reduced.

Market competition for selling cultural content within the online market is becoming increasingly fierce.

In this aspect, the need for a new content provision paradigm that may further stimulate the interest and curiosity of purchasers and enhance their desire to purchase content, thereby creating greater economic benefits and gaining an advantage in the relevant market economy is increasing day by day.

### DETAILED DESCRIPTION OF INVENTION

### Technical Problems

The present disclosure has been devised to obviate the above limitation of the related art. An aspect of the present disclosure is directed to implementing a method for providing a service based on an optional platform album capable of being purchased by selectively setting purchase options and a system therefor.

In detail, an embodiment of the present disclosure is directed to implementing a method for providing an optional platform album-based service, which provides a customized platform album including components set according to the needs of a purchaser when purchasing an online-based platform album, and a system therefor.

In addition, an embodiment of the present disclosure is directed to implementing a method for providing an optional platform album-based service, which supports a sales volume aggregation for the corresponding album based on the unique number and delivery code (invoice number) of the optional platform album purchased as described above, and a system therefor.

In addition, an embodiment of the present disclosure is directed to implementing a method for providing an optional platform album-based service, which provides a purchase authentication code and/or a random photo card related to the purchased optional platform album and provides a customized management service based thereon, and a system therefor.

### Technical Solution

A method for providing an optional platform album-based service according to an embodiment of the present disclosure, in which a platform application executed by at least one processor of a terminal provides an optional platform album-based service, includes: providing an optional platform album purchase interface; determining included components of an optional platform album based on the provided purchase interface; performing a payment process according to the determined included components; performing a delivery process according to the determined included components; and providing sales authentication information about the optional platform album based on a unique number of the optional platform album and a delivery code acquired based on the performed delivery process.

In this connection, the determination of the included components of the optional platform album includes determining components to be included in the optional platform album based on a purchase option set according to a user input based on the purchase interface.

In addition, the components include at least one of a predetermined CD, digital content, an album jacket, a pictorial, a photo card, or a special benefit.

In addition, the determination of the included components of the optional platform album further includes determining a customized offline configuration provided to a user offline and a customized online configuration provided to the user online.

In addition, the determination of the included components of the optional platform album further includes adding a purchase authentication code for at least one of the digital content or the photo card to the included components when the at least one of the digital content or the photo card is determined as the included components.

In addition, the purchase authentication code includes at least one of an offline authentication code provided to a user offline or an online authentication code provided to the user online.

In addition, the determination of the included components of the optional platform album further includes setting a randomly selected photo card from among a plurality of photo cards matching the optional platform album as the included components when the photo card is determined as the included components.

In addition, the photo card includes at least two of a predetermined image, a card identification code specifying the photo card, or a digital content provision code providing photo card content activated based on the photo card.

In addition, the performance of the payment process according to the determined included components includes determining a purchase cost of the optional platform album based on a price preset for each included component.

In addition, the performance of the delivery process according to the determined included components includes delivering the customized offline configuration to the user offline and delivering the customized online configuration to the user online.

In addition, the provision of the sales authentication information about the optional platform album includes reflecting the sales authentication information in an album sales volume aggregation for determining a predetermined album ranking chart.

In addition, the method for providing the optional platform album-based service according to an embodiment of the present disclosure further includes providing a customized management service for each included component in the optional platform album that has been purchased based on a presently performed payment process.

In addition, the provision of the customized management service includes performing a purchase authentication process based on at least one of an offline authentication code or an online authentication code of at least one of the digital content or the photo card when the included components in the optional platform album that has been purchased includes at least one of the digital content or the photo card.

In addition, the provision of the customized management service includes providing at least one of an owner authentication function for matching and storing a random photo card provided to the user to a user account, a collecting function for managing a random photo card that has been matched and stored to the user account, or an upgrade function for combining at least some of a plurality of random photo cards owned by the user when the included components in the optional platform album that has been purchased includes the photo card.

In addition, the provision of the upgrade function includes integrating photo card content for each of a plurality of material photo cards used in the combination into one piece of content.

A system for providing an optional platform album-based service according to an embodiment of the present disclosure includes: at least one memory in which a platform application is stored; and at least one processor for reading out the platform application stored in the memory and providing the optional platform album-based service; wherein instructions of the platform application include instructions for: providing an optional platform album purchase interface; determining included components of an optional platform album based on the provided purchase interface; performing a payment process according to the determined included components; performing a delivery process according to the determined included components; and providing sales authentication information about the optional platform album based on a unique number of the optional platform album and a delivery code acquired based on the performed delivery process.

In this connection, the instructions of the platform application further include instructions for reflecting the sales authentication information in an album sales volume aggregation for determining a predetermined album ranking chart.

In addition, the instructions of the platform application further include instructions for providing a customized management service for each included component in the optional platform album that has been purchased based on the performed payment process.

### Effect of Invention

A method and system for providing an optional platform album-based service according to an embodiment of the present disclosure can prevent issues such as unnecessary payment and purchase of undesirable configurations by a user when a platform album is provided only in a full package state including all components by providing a service based on an optional platform album that can be purchased by selectively setting purchase options, thereby reducing wasteful resources or costs.

In addition, the method and system for providing the optional platform album-based service according to an embodiment of the present disclosure can provide a customized platform album including components directly selected according to the needs of a purchaser when purchasing an online-based platform album, thereby enabling a user to flexibly determine an album purchase cost according to the components selected to purchase, thereby preventing excessive spending due to unnecessary consumption and supporting the performance of a purchase procedure based on a more reasonably calculated album purchase cost.

In addition, the method and system for providing the optional platform album-based service according to an embodiment of the present disclosure support sales volume aggregation for the optional platform album purchased as described above based on a unique number and delivery code (invoice number) of the album, thereby enabling album ranking aggregation within a specific chart to be performed more accurately and reliably based on official and objective sales data collected over a larger area.

In addition, the method and system for providing the optional platform album-based service according to an embodiment of the present disclosure support sales of the purchased optional platform album to be easily reflected in the album sales volume aggregation for calculating album ranking within a specific chart based on the unique number and delivery code (invoice number) of the purchased optional platform album, thereby enabling smooth application of the album sales volume aggregation only with the purchase of at least one component of the optional platform album, and thus further improving the accuracy of calculating the album sales volume parameter value for determining a predetermined album ranking chart.

In addition, the method and system for providing the optional platform album-based service according to an embodiment of the present disclosure can enhance the interest and curiosity of purchasers regarding the optional platform album and further increase their desire to purchase by providing a purchase authentication code and/or a random photo card related to the purchased optional platform album and providing a customized management service based thereon.

### BRIEF DESCRIPTION OF THE DRAWING

FIG. 1 is a conceptual diagram illustrating a system for providing an optional platform album-based service according to an embodiment of the present disclosure.

FIG. 2 is an internal block diagram illustrating a terminal according to an embodiment of the present disclosure.

FIG. 3 is a flowchart illustrating a method for providing an optional platform album-based service according to an embodiment of the present disclosure.

FIG. 4 is an example of a diagram illustrating an optional platform album purchase interface according to an embodiment of the present disclosure.

FIG. 5 is an example of a diagram illustrating a photo card collecting function according to an embodiment of the present disclosure.

FIG. 6 is an example of a diagram illustrating a photo card upgrade function according to an embodiment of the present disclosure.

FIG. 7 is an example of a diagram illustrating a method for combining a plurality of pieces of photo card content according to an embodiment of the present disclosure.

### BEST MODE FOR CARRYING OUT THE INVENTION

Embodiments of the present disclosure will be shown in the drawings and described in detail through a detailed description. However, the present disclosure may be variously modified and embodied in a variety of different embodiments. Advantages and features of the present disclosure and implementation methods thereof will be clarified through the following embodiments described with reference to the accompanying drawings. Therefore, the present disclosure is not limited to these embodiments introduced hereinafter and might be embodied in a different shape from these embodiments. The terms “first,” “second,” and so on in the present disclosure are used for distinguishing one component from the other components, but they do not specify limited meanings. Also, the singular forms used in the present disclosure are intended to include the plural forms, unless the context clearly indicates otherwise. Moreover, the terms “comprises” and/or “having” described in the present disclosure specify the presence of stated components and/or features, but do not preclude the presence or addition of one or more other components and/or features. Furthermore, the size or the thickness of each component in the drawings can be exaggerated or reduced for the definiteness of explanation. For example, the size and the thickness of each component in the drawings are arbitrarily represented for the convenience of explanation. In accordance therewith, the present disclosure is not limited to the matters shown in the drawings.

Reference will now be made in detail to the embodiments of the present disclosure with reference to the accompanying drawings. Wherever possible, the same reference numbers will be used throughout the disclosure including the drawings to refer to the same or like parts. As such, the repeatable description of the same or like parts will be omitted.

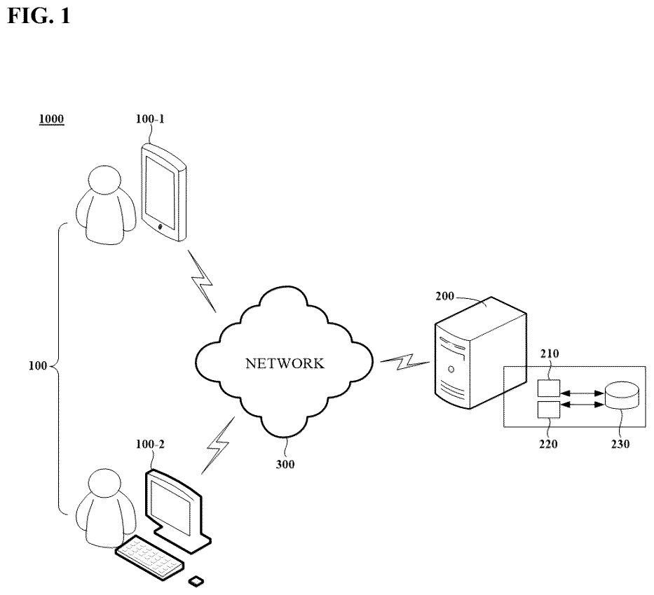

FIG. 1 is a conceptual diagram illustrating a system for providing an optional platform album-based service according to an embodiment of the present disclosure.

Referring to FIG. 1 a system 1000 for providing the optional platform album-based service according to an embodiment of the present disclosure (hereinafter, a “service provision system”) may provide a service based on an optional platform album that may be purchased by selectively setting purchase options (hereinafter, an “optional platform album service”).

In an embodiment, the service provision system 1000 implementing the optional platform album service as described above may include a terminal 100, a service platform server 200, and a network 300.

In this connection, the terminal 100 and the service platform server 200 may be connected through the network 400.

Herein, the network 300 according to an embodiment refers to a connection structure capable of exchanging information between nodes such as the terminal 100 and/or service platform server 200. Examples of the network 300 include 3GPP (3rd Generation Partnership Project) network, LTE (Long Term Evolution) network, WIMAX (World Interoperability for Microwave Access) network, Internet, LAN (Local Area Network), Wireless LAN (Wireless Local Area Network), WAN (Wide Area Network), PAN (Personal Area Network), Bluetooth network, Satellite Broadcasting Network, Analog Broadcasting Network, and DMB (Digital Multimedia Broadcasting) network, but are not limited thereto.

Hereinafter, the terminal 100 and the service platform server 200 that implement the service provision system 1000 will be described in detail with reference to the attached drawings.

### Terminal 100

The terminal 100 according to an embodiment of the present disclosure may be a computing device having a platform application (hereinafter, an “application”) installed that provides the optional platform album service.

Specifically, from a hardware point of view, the terminal 100 may include a mobile-type computing device 100-1 and/or a desktop-type computing device 100-2 in which the application is installed.

Herein, the mobile-type computing device 100-1 may be a mobile device such as a smartphone or tablet PC in which the application is installed.

For example, the mobile-type computing device 100-1 may include a smartphone, a mobile phone, a digital broadcasting terminal 100, a personal digital assistant (PDA), a portable multimedia player (PMP), and a tablet PC.

In addition, the desktop-type computing device 100-2 may include a device installed with a program to execute the optional platform album service based on wired/wireless communication such as a fixed-type desktop PC, a laptop computer, and a personal computer such as an ultrabook in which the application is installed.

In addition, according to an embodiment, the terminal 100 may further include a predetermined server computing device that provides an optional platform album service environment.

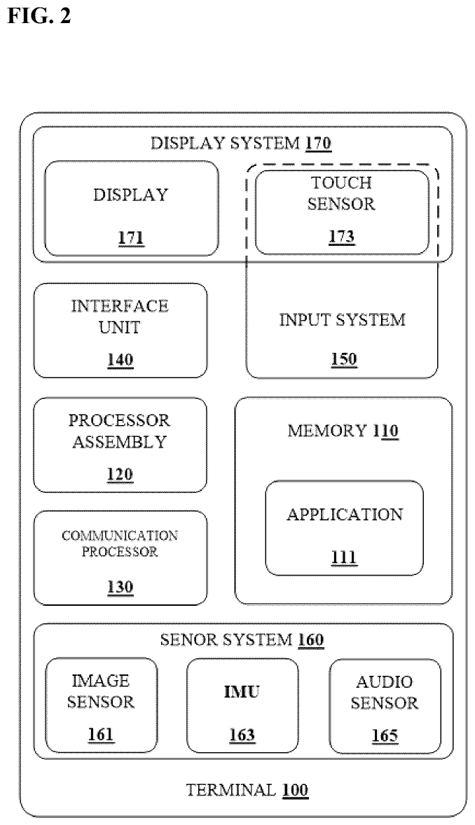

FIG. 2 is an internal block diagram of the terminal 100 according to an embodiment of the present disclosure.

Referring to FIG. 2, from a functional point of view, the terminal 100 may include a memory 110, a processor assembly 120, a communication processor 130, an interface module 140, an input system 150, a sensor system 160, and a display system 170. These components may be configured to be included within a housing of the terminal 100.

Specifically, the memory 110 may store an application 111, and the application 111 may store one or more of various application programs, data, and instructions for providing the optional platform album service environment.

In other words, the memory 110 may store commands and data used for creating the digital item provision service environment.

In addition, the memory 110 may include a program area and a data area.

Herein, the program area according to an embodiment may be linked between an operating system (OS) for booting the terminal 100 and functional elements, and the data area may store data generated according to the use of the terminal 100.

In addition, the memory 110 may include at least one non-transitory computer-readable storage medium and a temporary computer-readable storage medium.

For example, the memory 110 may be various storage devices, such as a ROM, an EPROM, a flash drive, and a hard drive; and may be a web storage performing a storage function of the memory 110 on the Internet.

The processor assembly 120 may include at least one processor capable of executing commands of the application 111 stored in the memory 110 to perform various tasks for creating the optional platform album service environment.

In an embodiment, the processor assembly 120 may control the overall operation of components through the application 111 of the memory 110 in order to provide the optional platform album service.

The processor assembly 120 may be a system-on-chip (SOC) suitable for the terminal 100 that includes a central processing unit (CPU) and/or graphics processing unit (GPU), may execute the OS and/or an application program stored in the memory 110, and control each component mounted on the terminal 100.

In addition, the processor assembly 120 may communicate with each component internally through a system bus and may include one or more predetermined bus structures including a local bus.

In addition, the processor assembly 120 may be implemented by using at least one of application-specific integrated circuits (ASICs), digital signal processors (DSPs), digital signal processing devices (DSPDs), programmable logic devices (PLDs), field programmable gate arrays (FPGAs), controllers, micro-controllers, microprocessors, or electric units for performing other functions.

The communication processor 130 may include one or more devices for communicating with an external device. The communication processor 130 may communicate through a wireless or wired network.

In detail, the communication processor 130 may communicate with the terminal 100 storing a content source for implementing the optional platform album service environment, and may communicate with various user input components such as a controller receiving a user input.

In an embodiment, the communication processor 130 may transmit/receive various pieces of data related to the optional platform album service to/from another terminal 100 and/or an external server.

This communication processor 130 may wirelessly transmit and receive data with at least one of a base station, an external terminal 100, or an arbitrary server on a mobile communication network built through a communication device capable of performing technical standards or communication methods (for example, LTE (Long Term Evolution), LTE-A (Long Term Evolution-Advanced), 5G NR (New Radio), and WIFI) or short-range communication methods for mobile communication.

The sensor system 160 may include various sensors such as an image sensor 161, a position sensor (IMU) 163, an audio sensor 165, a distance sensor, a proximity sensor, and a contact sensor.

Herein, the image sensor 161 may capture an image and/or a video of a physical space around the terminal 100.

In an embodiment, the image sensor 161 may capture and acquire various images and/or videos related to the optional platform album service.

In an embodiment, the image sensor 161 may acquire a captured image of a predetermined photo card and/or various identification codes.

In addition, the image sensor 161 may be disposed on the front or/and rear side of the terminal 100 to acquire an image by capturing the disposed direction side, and may capture a physical space through a camera disposed toward the outside of the terminal 100.

The image sensor 161 may include an image sensor device and a video processing module. Specifically, the image sensor 161 may process a still image or a moving image obtained by an image sensor device (for example, CMOS or CCD).

In addition, the image sensor 161 may process a still image or a moving image obtained through the image sensor device using an image processing module to extract necessary information, and transmit the extracted information to a processor.

The image sensor 161 may be a camera assembly including at least one or more cameras. The camera assembly may include a general camera that captures a visible light band, and may further include a special camera such as an infrared camera or a stereo camera.

In addition, the aforementioned image sensor 161 may be operated while being included in the terminal 100 according to an embodiment, or may be included in an external device (for example, an external server) to operate through interworking based on the aforementioned communication processor 130 and/or interface module 140.

The IMU 163 may sense at least one of motion and acceleration of the terminal 100. For example, the IMU 163 may include a combination of various position sensors such as an accelerometer, a gyroscope, and a magnetometer.

In addition, the IMU may interwork with the position communication processor 130 such as GPS of the communication processor 130 to recognize spatial information on the physical space around the terminal 100.

The audio sensor 165 may recognize a sound around the terminal 100.

In detail, the audio sensor 165 may include a microphone capable of sensing a speech input of a user using the terminal 100.

In an embodiment, the audio sensor 165 may receive speech data necessary for the optional platform album service from a user.

The interface module 140 may communicatively connect the terminal 100 with one or more other devices. Specifically, the interface module 140 may include wired and/or wireless communication devices that are compatible with one or more different communication protocols.

The terminal 100 may be connected to various input/output devices through the interface module 140.

For example, the interface module 140 may be connected to an audio output device such as a headset port or a speaker to output audio.

Although it has been described as an example that the audio output device is connected through the interface module 140, an embodiment in which the audio output device is installed in the terminal 100 may also be included.

In addition, for example, the interface module 140 may be connected to an input device such as a keyboard and/or mouse to acquire a user input.

This interface module 140 may include at least one of a wired/wireless headset port, an external charger port, a wired/wireless data port, a memory card port, a port for connecting a device equipped with an identification module, an audio input/output (I/O) port, a video I/O port, an earphone port, a power amplifier, an RF circuit, a transceiver or other communication circuits.

The input system 150 may sense a user input (for example, a gesture, a speech command, operation of a button, or other type of input) related to the optional platform album service.

Specifically, the input system 150 may include a predetermined button, a touch sensor, and/or an image sensor 161 that receives a user motion input.

In addition, the input system 150 may be connected to an external controller through the interface module 140 to receive a user input.

The display system 170 may output various pieces of information related to the optional platform album service as a graphic image.

In an embodiment, the display system 170 may display various user interfaces for the optional platform album service (as an example, an optional platform album purchase interface, a purchase authentication interface, a photo card collecting interface, and/or a card return interface).

Such display may include at least one of a liquid crystal display (LCD), a thin film transistor-liquid crystal display (TFT LCD), an organic light-emitting diode (OLED), and a flexible display, a 3D display, or an electronic ink display (e-ink display).

The above components may be disposed within the housing of the terminal 100, and a user interface may include a touch sensor 173 on a display 171 configured to receive a user touch input.

In detail, the display system 170 may include the display 171 that outputs an image and the touch sensor 273 that senses a user touch input.

For example, the display 171 may form an overlaid structure with the touch sensor 173 or integrally formed to be implemented as a touch screen. Such a touch screen may function as a user input unit that provides an input interface between the terminal 100 and the user, and may provide an output interface between the terminal 100 and the user.

In addition, according to an embodiment, the terminal 100 may further perform at least a portion of functional operations performed by the service platform server 200, which will be described later.

### Service Platform Server 200

The service platform server 200 according to an embodiment of the present disclosure may perform a series of processes for providing the optional platform album service.

In detail, in an embodiment, the service platform server 200 may provide the optional platform album service by exchanging data necessary to enable for an optional platform album service process to drive in an external device such as the terminal 100 with the external device.

In more detail, in an embodiment, the service platform server 200 may provide an environment in which the application 111 may operate in an external device (in an embodiment, the mobile-type computing device 100-1 and/or the desktop-type computing device 100-2).

To this end, the service platform server 200 may include application programs, data and/or instructions for the application 111 to operate, and may transmit and receive various pieces of data based thereon with the external device.

In addition, in an embodiment, the service platform server 200 may provide a user interface (in an embodiment, an optional platform album purchase interface) that may perform a purchase process for a predetermined optional platform album.

In addition, in an embodiment, the service platform server 200 may set a purchase option based on a user (in other words, a purchaser) input based on the optional platform album purchase interface provided above.

Herein, the purchase option according to an embodiment may include the inclusion of a predetermined CD, digital content (for example, digital sound source and/or video), album jacket, pictorial, photo card, and/or special benefits (for example, offline fan meeting or concert ticket purchase rights, or NFT related to the album).

In addition, in an embodiment, the service platform server 200 may determine a customized delivery configuration according to the aforementioned purchase option.

Herein, the customized delivery configuration according to an embodiment may mean predetermined components (in an embodiment, CD, digital content, album jacket, pictorial, photo card, and/or special benefits) determined to be included in the optional platform album according to the purchase options set as above.

In addition, in an embodiment, the service platform server 200 may execute a payment and delivery process according to the determined customized delivery configuration.

In addition, in an embodiment, the service platform server 200 may provide sales authentication information based on the optional platform album purchased (paid for) as described above.

Herein, the sales authentication information according to an embodiment may mean information authenticating that a series of sales procedures for the optional platform album have been completed normally.

In addition, in an embodiment, the service platform server 200 may provide a customized management service for each component (in an embodiment, CD, digital content, album jacket, pictorial, photo card, and/or special benefits) in the optional platform album purchased (paid for).

In addition, in an embodiment, the service platform server 200 may store and manage various application programs, instructions, and/or data for implementing the optional platform album service.

In an embodiment, the service platform server 200 may store and manage at least one optional platform album, album components, purchase options, customized delivery configurations, purchase authentication codes, digital content provision codes, purchase costs, delivery codes (invoice numbers), album unique numbers, sales authentication information, photo card images, photo card information owned by users (in other words, purchasers), integrated content, and/or various user interfaces.

However, the functional operations that the service platform server 200 may perform in an embodiment of the present disclosure are not limited to those described above, and other functional operations may be further performed.

Referring further to FIG. 1, in an embodiment, the service platform server 200 as described above may be implemented as a predetermined computing device including at least one processor module 210 for data processing, at least one communication module 220 for data exchange with an external device, and at least one memory module 230 for storing various application programs, data, and/or instructions for providing the optional platform album service.

Herein, the memory module 230 may store one or more of an operating system (OS), various application programs, data, or instructions for providing the optional platform album service.

In addition, the memory module 230 may include the program area and the data area.

Herein, the program area according to an embodiment may be linked between the OS for booting a server and functional elements, and the data area may store data generated according to the use of the server.

In an embodiment, the memory module 230 may be various storage devices, such as a ROM, a RAM, an EPROM, a flash drive, and a hard drive, and may be a web storage performing a storage function of the memory module 230 on the Internet.

In addition, the memory module 230 may be a detachable recording medium on a server.

The processor module 210 may control the overall operation of each unit to implement the optional platform album service.

The processor module 210 may be the SOC suitable for the server that includes the CPU and/or GPU, may execute the OS and/or an application program stored in the memory module 230, and control each component mounted on the server.

In addition, the processor module 210 may communicate with each component internally through a system bus and may include one or more predetermined bus structures including a local bus.

In addition, the processor module 210 may be implemented by using at least one of the ASICS, DSPs, DSPDs, PLDs, FPGAs, controllers, micro-controllers, microprocessors, or electric units for performing other functions.

In the above description, it has been described that the service platform server 200 according to an embodiment of the present disclosure performs the functional operation as described above. However, according to an embodiment, various embodiments may be possible, such as performing at least a portion of the functional operation performed by the service platform server 200 (for example, the terminal 100), and further performing at least a portion of the functional operation performed in the external device in the service platform server 200.

### Method for Providing Optional Platform Album-Based Service

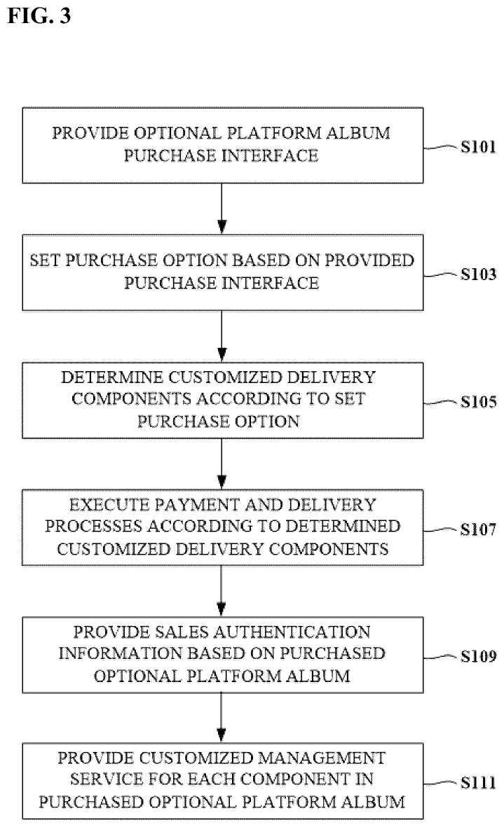

Hereinafter, a method for providing an optional platform album-based service by the application 111 executed by at least one processor of the terminal 100 according to an embodiment of the present disclosure will be described in detail with reference to the attached FIGS. 3 to 7.

In an embodiment of the present disclosure, the at least one processor of the terminal 100 may execute at least one application 111 stored in at least one memory 110 or operate the same in a background state.

Hereinafter, the method for providing the optional platform album-based service described above by having the at least one processor operate to execute instructions of the application 111 is briefly described as being performed by the application 111.

FIG. 3 is a flowchart illustrating a method for providing an optional platform album-based service according to an embodiment of the present disclosure.

Referring to FIG. 3, in an embodiment, the application 111 executed by the at least one processor of the terminal 100 or operating in a background state may provide an optional platform album purchase interface (S101).

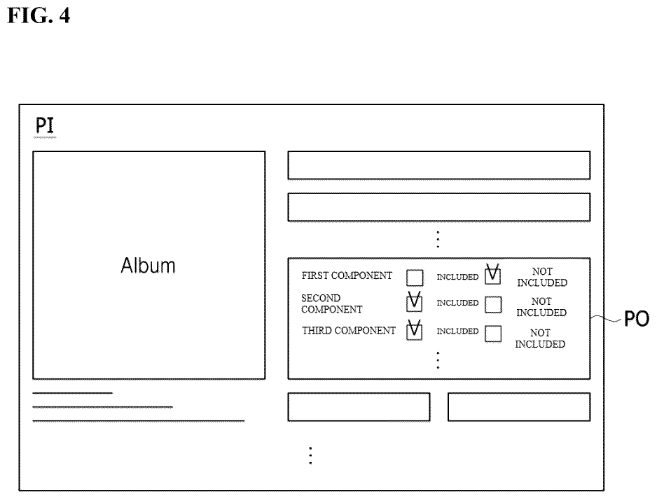

FIG. 4 is an example of a diagram illustrating an optional platform album purchase interface according to an embodiment of the present disclosure.

Referring to FIG. 4, the platform album according to an embodiment may mean an online/offline album released for a predetermined target (for example, a specific artist) sold online.

In addition, the optional platform album according to an embodiment may be a platform album that may be purchased by selectively setting components of the platform album, in other words, selectively setting a purchase option (PO) for the platform album.

In an embodiment, the purchase option (PO) of the platform album may include the inclusion of a predetermined CD, digital content (for example, digital sound source and/or video), album jacket, pictorial, photo card, and/or special benefits (for example, offline fan meeting or concert ticket purchase rights, or NFT related to the album).

In other words, in an embodiment, the application 111 may provide an optional platform album purchase interface (PI) that may purchase a platform album by setting a purchase option (PO) as described above.

In this connection, in an embodiment, the optional platform album purchase interface (PI) may include a user interface that may selectively set the inclusion of each component (in other words, the purchase option (PO)), a product (in an embodiment, an optional platform album) description interface, and/or a purchase process progress interface.

In addition, in an embodiment, the application 111 may set the purchase option (PO) based on the purchase interface provided above (S103).

In detail, in an embodiment, the application 111 may determine the purchase option (PO) for a platform album that a user wishes to purchase based on a user (in other words, a purchaser) input based on the optional platform album purchase interface (PI) provided above.

For example, the application 111 may determine the purchase option (PO) for a first optional platform album based on a user input that selects components to be included in the first optional platform album, such as “CD: not included, digital content: included, album jacket: included, pictorial: included, photo card: included, and special feature: not included” for the first optional platform album.

As such, the application 111 supports a user to configure an optional platform album by directly selecting the necessary components, thereby preventing issues in advance such as unnecessary payment and purchase for a configuration that the user does not want when the platform album is provided only in a full packaging state including all components, and thus effectively reducing wasted resources or costs.

In addition, in an embodiment, the application 111 may determine a customized delivery configuration according to the set purchase option (PO) (S105).

In detail, the customized delivery configuration according to an embodiment may mean predetermined components (in an embodiment, a CD, digital content (in an embodiment, a digital sound source and/or video), an album jacket, a pictorial, a photo card, and/or special benefits) determined to be included in the optional platform album according to the set purchase option (PO).

In an embodiment, such customized delivery configurations may include a customized offline configuration provided to a user offline and a customized online configuration provided to the user online.

In more detail, in an embodiment, the application 111 may determine the customized delivery configuration based on the components (hereinafter, included components) determined to be included in the optional platform album according to the purchase option (PO) setting.

For example, when the purchase options (PO) for the first optional platform album are set as “CD: not included, digital content: included, album jacket: included, pictorial: included, photo card: included, and special feature: not included,” the application 111 may determine the album jacket, the pictorial and the photo card as the customized offline configuration and determine the digital content as the customized online configuration, thereby determining the customized delivery configuration for the first optional platform album.

In this connection, in an embodiment, when the digital content and/or photo card are set as the included components according to the purchase option (PO), the application 111 may include a purchase authentication code for the digital content and/or photo card in the corresponding customized delivery configuration.

Herein, the purchase authentication code according to an embodiment may be a predetermined identification code (for example, QR code, serial number, and/or authentication number) that authenticates the purchase of the corresponding digital content and/or photo card.

In an embodiment, such purchase authentication codes may include an offline authentication code, which is a purchase authentication code provided offline (for example, a printed matter displaying the purchase authentication code) and/or an online authentication code, which is a purchase authentication code provided online (for example, a digital image displaying the purchase authentication code).

In detail, in an embodiment, the application 111 may include an offline authentication code for the digital content and/or photo card in the customized offline configuration when the digital content and/or photo card is set as the included component according to the purchase option (PO).

For example, the offline authentication code for the digital content may be a printed matter displaying a purchase authentication code for the digital content, and the offline authentication code for the photo card may be provided by being displayed on the photo card.

Alternatively, in an embodiment, the application 111 may include an online authentication code for the digital content and/or photo card in the customized online configuration when the digital content and/or photo card is set as the included component according to the purchase option (PO).

For example, the online authentication code for the digital content and/or photo card may be a digital image or the like that displays a purchase authentication code for the digital content and/or photo card.

Thus, the application 111 may support easy purchase authentication of the digital content and/or photo card not only offline but also online when a predetermined digital content and/or photo card is purchased based on an optional platform album in the future. A detailed explanation thereof will be provided later.

Thereafter, in an embodiment, when purchase authentication based on the offline authentication code and/or online authentication code for the digital content and/or photo card is completed, the application 111 may activate the digital content and/or digital content based on the photo card in an available state. A detailed explanation thereof will be provided later.

In an embodiment, when the photo card is set as the included component according to the purchase option (PO), the application 111 may include a photo card (hereinafter, “random photo card”) randomly selected from among a plurality of photo cards presently created for the optional platform album according to a predetermined method as a customized offline configuration of the customized delivery configuration.

Herein, the photo card according to an embodiment may mean a physical card including a predetermined image associated with the target of the optional platform album (for example, a specific artist), a card identification code providing identification information (for example, a card unique number) that specifies the photo card, and/or a digital content provision code.

In this connection, the digital content provision code according to an embodiment may be a predetermined identification code (for example, QR code or barcode) that provides predetermined digital content (hereinafter, photo card content) uniquely implemented through the corresponding photo card by being sensed through the image sensor 161.

In other words, the application 111 may increase the purchase rate of users (in other words, purchasers) by randomly selecting and sending photo cards, each of which provides a unique image or digital content, thereby inducing a desire to collect the same.

In addition, in an embodiment, the application 111 may execute a payment and delivery process according to the determined customized delivery configuration (S107).

In detail, in an embodiment, the application 111 may execute a payment process and a delivery process for the optional platform album based on the customized delivery configuration determined as above.

Herein, the payment process according to an embodiment may include normal functional operations (for example, setting a payment method and/or delivery address) supporting online payment for a predetermined product (for example, an optional platform album according to a customized delivery configuration, in an embodiment). Hereinafter, the functional operations specific to the embodiment of the present disclosure will be mainly described.

In addition, the delivery process according to an embodiment may include normal functional operations (for example, FTP-based data transmission/reception and/or data transmission/reception with a predetermined delivery server (for example, a predetermined post office server) matching a delivery address) supporting a series of delivery processes for delivering a predetermined product (in an embodiment, an optional platform album according to a customized delivery configuration, in an embodiment) to a user (in other words, a purchaser) online/offline. Hereinafter, the functional operations specific to the embodiment of the present disclosure will be mainly described.

In more detail, in an embodiment, the application 111 may execute a payment process for the optional platform album.

In addition, in an embodiment, the application 111 may determine the purchase cost for the optional platform album based on the customized delivery configuration through the executed payment process.

Specifically, the application 111 may determine the purchase cost of the optional platform album based on price data preset for each component of the optional platform album (in an embodiment, a predetermined CD, digital content, album jacket, pictorial, photo card, and/or special benefits).

In an embodiment, the application 111 may calculate a sum of all preset prices for each customized delivery configuration (in other words, included components) for the optional platform album to determine the purchase cost of the optional platform album.

In other words, the application 111 may dynamically determine the purchase cost for the optional platform album according to the purchase option (PO) determined by user selection, thereby preventing excessive spending due to unnecessary consumption and supporting the execution of a purchase procedure according to a more reasonably calculated album purchase cost.

In an embodiment, the application 111 may execute an on/offline delivery process for the optional platform album.

In detail, in an embodiment, the application 111 may execute an online delivery process according to a customized online configuration of the customized delivery configuration.

In more detail, in an embodiment, the application 111 may execute the online delivery process by displaying and providing the customized online configuration (in an embodiment, a purchase authentication code).

Thus, the application 111 may provide in advance online a customized delivery configuration (in an embodiment, a purchase authentication code) that may be provided online even before the customized delivery configuration determined for the optional platform album is delivered offline to the user (in other words, the purchaser). Accordingly, when a user (in other words, the purchaser) purchases digital content, the purchase authentication code for purchase authentication of the digital content may be received online in advance even before receiving the offline, thereby making the digital content available more quickly.

In an embodiment, the application 111 may execute an offline delivery process according to a customized offline configuration of the customized delivery configuration by linking with a predetermined delivery server.

In detail, in an embodiment, the application 111 may support an offline delivery procedure for the customized offline configuration based on the delivery address information acquired in the payment process described above by executing the offline delivery process.

For example, when the customized offline configuration includes “album jacket, pictorial and photo card,” the application 111 may support an offline delivery procedure for delivering the “album jacket, pictorial and photo card” to a user (in other words, a purchaser) offline by linking with a predetermined delivery server.

As another example, when the customized offline configuration includes an “offline authentication code,” the application 111 may support an offline delivery procedure that delivers the “offline authentication code” to a user (in other words, a purchaser) offline by linking with a predetermined delivery server.

In this connection, in an embodiment, the application 111 may acquire a delivery code (in other words, invoice number) created as the offline delivery procedure is performed from the linked delivery server.

Herein, the delivery code according to an embodiment may mean a predetermined identification information assigned to specify the corresponding product (in an embodiment, an optional platform album according to the customized offline configuration) in an offline delivery process.

In other words, the application 111 may receive and acquire a delivery code (invoice number), which is a predetermined identification information matching an optional platform album that is delivered offline to a user (in other words, a purchaser) by linking with the delivery server.

In an embodiment of the present disclosure, the application 111 may implement a sales authentication process for the optional platform album by utilizing the delivery code acquired as described above. A detailed explanation thereof will be provided later.

In addition, in an embodiment, the application 111 may provide sales authentication information based on the purchased optional platform album (S109).

Herein, the sales authentication information according to an embodiment may mean information that authenticates that a series of sales procedures for the optional platform album have been normally completed when the album is purchased (paid for) as described above.

In an embodiment, such sales certification information may be provided to a predetermined album ranking aggregation server (for example, a Gaon Chart server) and may be the base data reflected in the album sales volume parameter value for determining a predetermined album ranking chart provided by the album ranking aggregation server.

In detail, in an embodiment, the application 111 may create sales authentication information for the purchased optional platform album (hereinafter, a payment album).

In more detail, in an embodiment, the application 111 may create sales authentication information for the payment album based on the album unique number preset for each optional platform album and the delivery code (invoice number) acquired as offline delivery is in progress.

Specifically, in an embodiment, the application 111 may acquire an album unique number that is presently matched to the payment album and a delivery code (invoice number) that is created as offline delivery of the payment album is in progress.

In an embodiment, the application 111 may acquire the album unique number of the payment album by reading the same out from the memory 110 and/or linking the same with an external server (for example, the service platform server 200).

In addition, in an embodiment, the application 111 may acquire the delivery code of the payment album by linking with the delivery server described above.

In addition, in an embodiment, the application 111 may create sales authentication information for the payment album, including the album unique number and delivery code acquired as described above.

In addition, in an embodiment, the application 111 may provide (transmit) the created sales authentication information to a predetermined album ranking aggregation server (for example, the Gaon Chart server).

Then, the album ranking aggregation server that has received the sales certification information may determine the ranking of each album within the album ranking chart by reflecting the received sales certification information in the album sales volume parameter value for determining a predetermined album ranking chart provided by the album ranking aggregation server.

In an embodiment, the album ranking aggregation server may perform a validity determination on the delivery code within the sales authentication information when the sales authentication information is received.

For example, the album ranking aggregation server may determine the validity of the delivery code in the received sales authentication information by linking with a predetermined delivery server (for example, a predetermined post office server).

In addition, in an embodiment, the album ranking aggregation server may increase the sales volume of an album corresponding to the album unique number in the sales authentication information when the delivery code is determined to be valid through the validity determination.

Thus, the album ranking aggregation server may determine the album ranking chart by reflecting the sales certification information.

As such, the application 111 creates sales certification information for the corresponding platform album based on the album unique number preset for each optional platform album and the delivery code (invoice number) according to offline delivery of the corresponding optional platform album, and provides the same to a predetermined album ranking aggregation server to support reflection in the album sales volume, thereby enabling the collection of sales authentication information for the corresponding platform album over a larger area based on official and objective data, and enabling the aggregation of the album ranking chart to be performed more accurately and reliably by reflecting the sales authentication information collected over a wider area.

In addition, the application 111 performs sales authentication by utilizing the delivery code created during the delivery process even when only some components of an optional platform album are purchased, thereby enabling smooth application of the purchase of at least one component of an optional platform album to the corresponding album sales volume aggregation, thereby further improving the accuracy of calculating the album sales volume parameter value for determining a predetermined album ranking chart.

In addition, in an embodiment, the application 111 may provide customized management services for each component within the purchased optional platform album (S111).

In other words, in an embodiment, the application 111 may provide a customized management service according to the components included in the payment album.

In detail, in an embodiment, the application 111 may provide a customized management service based on a purchase authentication code provided for the digital content when 1) the component included in the payment album is digital content.

In more detail, in an embodiment, when the purchase authentication code is an offline authentication code (for example, a printed matter displaying the purchase authentication code), the application 111 may sense the offline authentication code through the image sensor 161 and perform a purchase authentication process for the corresponding digital content.

Thus, the application 111 may make the digital content (for example, digital sound source and/or video) available for streaming (downloading) upon completion of the purchase authentication.

In addition, in an embodiment, the application 111 may perform a purchase authentication process for the corresponding digital content by inputting the online authentication code into a predetermined purchase authentication interface (for example, a purchase authentication interface provided by the service platform server 200) when the purchase authentication code is an online authentication code (for example, a digital image displaying a purchase authentication code), and when the purchase authentication is completed, the corresponding digital content (for example, digital sound source and/or video) may be streamed (downloaded) and made available for use.

In other words, the application 111 may improve convenience by supporting purchase authentication for the purchased digital content in any online/offline manner, and may more effectively reduce the time and cost required to use the digital content by enabling purchase authentication online even without receiving the purchase authentication code offline.

According to an embodiment, the application 111 may determine whether to approve a refund (return) request based on the purchase authentication code when the refund (return) for the payment album is requested.

In detail, in an embodiment, when a refund (return) request for the payment album is received, the application 111 may check whether purchase authentication for the purchase authentication code matching the payment album has been completed.

In addition, the application 111 may not allow the refund (return) request when the purchase authentication code has been completed for purchase authentication, in other words, has been processed for use.

The application 111 may permit the refund (return) request when the purchase authentication of the purchase authentication code is not completed, in other words, is unused.

Accordingly, the application 111 may easily block adverse effects and abuse cases resulting from using the online delivery process by preventing refund (return) processing for albums that have been legitimately used online even before the albums are delivered offline.

In addition, in an embodiment, the application 111 may provide a customized management service based on a random photo card that is randomly selected and provided as described above, 2) when the included component in the payment album is a photo card.

In detail, in an embodiment, the application 111 may perform a purchase authentication process for a photo card of the payment album based on a purchase authentication code provided for the random photo card.

For a detailed explanation thereof, the description of the purchase authentication process based on the purchase authentication code of the digital content described above will apply.

In other words, in an embodiment, the application 111 may support purchase authentication for the purchased photo card in any online/offline manner, and may enable purchase authentication online even without receiving the purchase authentication code offline, thereby reducing the time and cost required to use photo card content based on the photo card.

In addition, in an embodiment, the application 111 may provide a photo card management service based on the random photo card provided above.

Herein, the photo card management service according to an embodiment may mean a service that provides an owner authentication function that matches and stores a random photo card provided to a user (in other words, a purchaser) to a corresponding user account, a collecting function that manages (confirms/views/activates) a random photo card matched and stored to the user account in a predetermined manner (for example, by album and/or entire photo card list), and/or an upgrade function that combines (synthesizes/reinforces) a plurality of random photo cards.

In detail, in an embodiment, the application 111 may provide: 1) the owner authentication function for the random photo card.

In more detail, in an embodiment, the application 111 may acquire a photo card image by capturing the random photo card based on the image sensor 161.

In addition, in an embodiment, the application 111 may sense a card identification code (for example, a QR code or barcode) displayed on the random photo card based on the image sensor 161.

In addition, the application 111 may acquire identification information (for example, card unique number) that specifies the random photo card based on the sensed card identification code.

In addition, in an embodiment, the application 111 may store the photo card image and card identification code acquired as described above by matching the same to the user account.

Thus, the application 111 may check the actual owner of each randomly selected and sent photo card (in other words, random photo card), smoothly provide basic data that may be required for various user services utilizing the same, and also allow users (in other words, purchasers) to easily manage their own random photo cards online by linking the same to their own account as well as the actual photo cards.

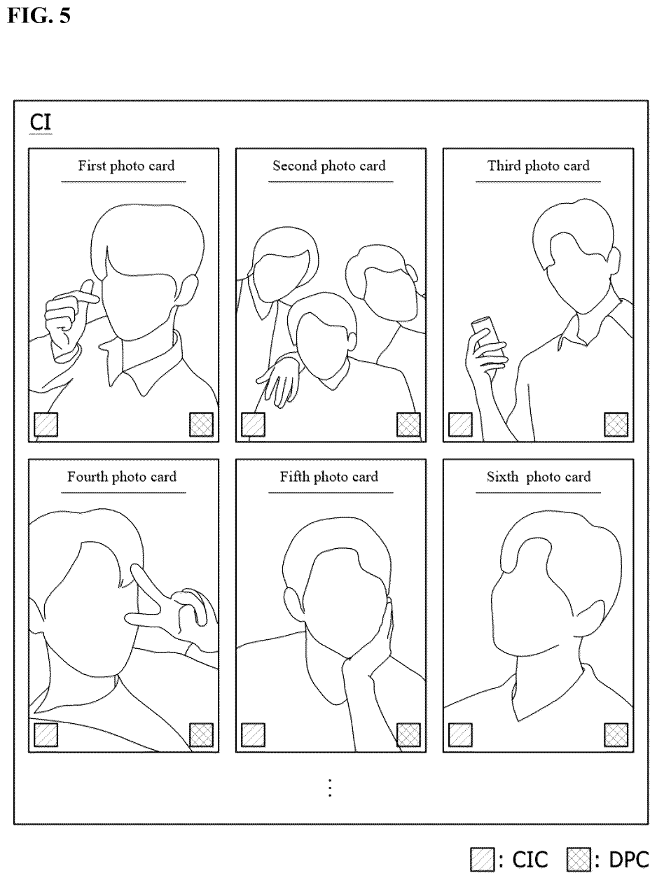

FIG. 5 is an example of a diagram illustrating a photo card collecting function according to an embodiment of the present disclosure.

In addition, referring to FIG. 5, in an embodiment, the application 111 may provide 2) a collecting function based on the random photo card.

In detail, in an embodiment, the application 111 may provide a photo card collecting interface (CI) that may manage (confirm/view/activate) at least one random photo card matched and stored in the user account according to a predetermined method when login according to the user (in other words, purchaser) account is approved.

In addition, in an embodiment, the application 111 may display and output at least one random photo card image stored in conjunction with a user account as described above based on the photo card collecting interface provided above in a predetermined manner (for example, by album and/or as a full photo card list).

In this connection, in an embodiment, the application 111 may activate photo card content for each random photo card matched and stored in the user account based on the photo card collecting interface (CI).

In detail, in an embodiment, the application 111 may select one of at least one random photo card image based on a user input based on the photo card collecting interface (CI).

In addition, in an embodiment, the application 111 may recognize the card identification code (CIC) and/or digital content provision code (DPC) displayed on the selected random photo card image and activate the photo card content, which is digital content (for example, digital sound source and/or video) uniquely implemented through the random photo card.

In other words, the application 111 may improve the usability and utilization of photo cards owned by users by supporting the application 111 to collectively check and manage all photo cards purchased by users (in other words, purchasers) through a single user interface (the photo card collecting interface (CI) in an embodiment) and to activate digital content (photo card content in an embodiment) based thereon.

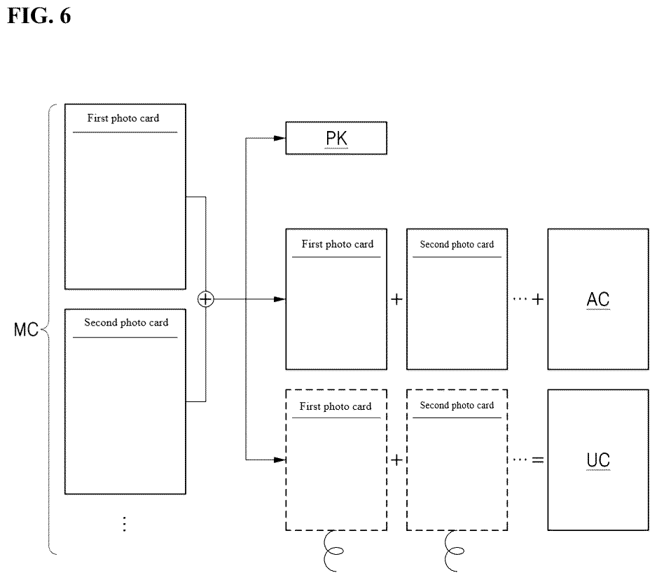

FIG. 6 is an example of a diagram illustrating a photo card upgrade function according to an embodiment of the present disclosure.

In addition, referring to FIG. 6, in an embodiment, the application 111 may provide 3) an upgrade function based on the random photo card.

In detail, in an embodiment, the application 111 may provide an upgrade function that combines (synthesizes/reinforces) a plurality of random photo cards stored in conjunction with a user account as described above according to a predetermined criterion.

For example, the application 111 may combine the plurality of random photo cards based on a predetermined criterion such as preset artists, artist groups, and/or combination conditions (for example, related to a specific concert and/or album).

In this connection, in an embodiment, the application 111 may provide a reward according to the combination.

In detail, in an embodiment, the application 111 may determine whether a combination is successful according to the predetermined criterion.

In more detail, the application 111 provides a predetermined quiz whose difficulty level is adjusted based on a preset grade for each of a plurality of random photo cards that meet the predetermined criterion. When the correct answer to the quiz provided above is acquired, the combination may be processed as successful.

Herein, the grade according to an embodiment is a predetermined factor indicating the rarity of each random photo card, and in an embodiment, this grade may be set in the form of a predetermined number, alphabet, and/or star rating.

For example, the grade may be pre-designated for each random photo card by a designated manager determining the grade based on its rarity, and in this connection, the rarer the random photo card, the higher its grade may be.

For example, a plural types of random photo cards of artist A may have grades such as grade C/grade B/grade A/grade S/grade SS matched according to their rarity.

In addition, depending on an embodiment, the grade may be set based on the content quantity and/or quality of the NFT matched to the corresponding random photo card.

In an embodiment, the rank may be set to increase or decrease in proportion to the quantity and/or quality of the random photo card.

Returning again, in more detail, the application 111 may generate and provide a predetermined quiz whose difficulty level is determined based on the grades of a plurality of preset random photo cards as described above.

In this connection, for example, the quiz may be a multiple-choice or subjective question related to a target (for example, a specific artist (and/or artist group)) matching the random photo card.

As an example, the application 111 may generate a quiz with a low difficulty level when the grade of the plurality of random photo cards that a user uses for combinations (synthesis/reinforcement) and/or the grade of the photo card that may be acquired through upgrades based on the plurality of random photo cards is low.

In an embodiment, the application 111 may generate a quiz with a high difficulty level when the grade of the plurality of random photo cards that a user uses for combinations (synthesis/reinforcement) and/or the grade of the photo card that may be acquired through upgrades based on the plurality of random photo cards is high.

Thus, the application 111 may increase the combination success probability (correct answer probability) of a user when the grades of the plurality of random photo cards and/or the acquirable photo cards are low, and may decrease the combination success probability (correct answer probability) of a user when the grades of the plurality of random photo cards and/or the acquirable photo cards are high.

In other words, the application 111 controls the correct answer probability (in other words, combination (synthesis/reinforcement) success probability) by providing a quiz with a differential difficulty level according to the grades of the plurality of random photo cards used for the upgrade, thereby providing additional photo cards and/or upper photo cards as a reward with an acquisition probability appropriate to the grades of the plurality of random photo cards used for the upgrade, thereby appropriately maintaining their rarity and value, and further reducing the gambling nature of a combination (synthesis/reinforcement) process.

In addition, in an embodiment, when the correct answer to the predetermined quiz provided as above is acquired, the application 111 may successfully process the combination (synthesis/reinforcement) according to the plurality of random photo cards.

In addition, in an embodiment, the application 111 may provide a reward, such as a predetermined special benefit (PK: for example, an offline fan meeting or concert ticket purchase right, or an NFT related to the corresponding album), an additional photo card, and/or an upper photo card when the combination (synthesis/reinforcement) is successful.

Herein, the additional photo card (AC) according to an embodiment may mean a random photo card that is additionally newly provided to the user (in other words, the purchaser) according to the success of the combination.

In this connection, in an embodiment, the method in which the additional photo card (AC) is provided may be implemented in the same manner as the method in which the purchased photo card is provided as described above. A detailed description thereof is based on the description of the method in which the purchased photo card is provided.

In addition, the upper photo card (UC) according to an embodiment may mean a photo card that may be selected with a lower probability compared to the random selection probability of each of the plurality of random photo cards (MC: hereinafter, a plurality of material photo cards) used in the combination (in other words, the probability that each of the plurality of material photo cards is randomly selected from among the plurality of photo cards presently created for the optional platform album).

In other words, the upper photo card (UC) may be a rarer photo card with a lower acquisition probability (in other words, higher grade) than the material photo cards (MC) used in the combination.

As such, the application 111 enables a user (in other words, a purchaser) to combine at least some (in an embodiment, the plurality of material photo cards (MC)) of a plurality of random photo cards in his/her possession in a predetermined manner and provides a reward accordingly, thereby further enhancing the interest and curiosity of the user (in other words, the purchaser) in the photo cards of the optional platform album and also increasing the purchase rate.

In this connection, in an embodiment, the application 111 may execute a return process for the plurality of material photo cards (MC) used in the combination by providing the upper photo card (UC) as described above as the reward.

In detail, in an embodiment, the application 111 may provide a card return interface that requests the return of a physical photo card (hereinafter, “material physical photo card”) for the plurality of material photo cards (MC) and supports the return delivery process accordingly.

In addition, in an embodiment, the application 111 may execute a process of delivering offline a physical photo card (hereinafter, “upper physical photo card”) for the upper photo card (UC) provided as a reward for the combination to the corresponding user (in other words, purchaser) when the return of the material physical photo card is completed based on the card return interface.

Thus, the application 111 may easily preserve its rarity by limiting the indiscriminate supply of photo cards.

According to an embodiment, the application 111 may also execute a disposal authentication process for the plurality of material photo cards used in the combination when the upper photo card is provided as described above as the reward.

In detail, in an embodiment, the application 111 may acquire a photo card deactivation authentication factor for the plurality of material photo cards.

Herein, the photo card deactivation authentication factor according to an embodiment is a predetermined means for authenticating deactivation (in other words, disposal) of the plurality of material photo cards, and in an embodiment, may be a deactivation identification code and/or a disposal video.

In this connection, the deactivation identification code according to an embodiment may mean a predetermined identification code (for example, a predetermined serial number, QR code, and/or barcode) that is revealed externally when the scratch field on each physical photo card of the plurality of material photo cards is removed.

In other words, in an embodiment, the scratch field may be an area that displays the deactivation identification code hidden under the scratch field when removed in a predetermined manner (for example, by scratching with a coin).

These deactivation identification codes may be stored and managed by matching the same with the card identification codes corresponding to the corresponding physical photo cards.

The aforementioned disposal video according to an embodiment may mean an image and/or video of a scene in which a disposing action (for example, incineration and/or cutting action) is performed on each physical photo card of the plurality of material photo cards.

In an embodiment, such a disposal video may include a frame that captures and displays the card identification code of the corresponding physical photo card. When the disposal video lacks a frame including the card identification code, disposal authentication based thereon may not be approved later on.

Returning to the above, in an embodiment, the application 111 may acquire the photo card deactivation authentication factor for the plurality of material photo cards based on a deactivation photo card image capturing the plurality of material photo cards displaying the deactivation identification code and/or a user input for inputting the deactivation identification code.

In an embodiment, the application 111 may perform image recognition based on the deactivated photo card image to detect at least one deactivation identification code included in the deactivated photo card image.

In addition, the application 111 may acquire the detected deactivation identification code as the deactivation authentication factor.

Alternatively, in an embodiment, the application 111 may acquire the deactivation identification code for each of the plurality of corresponding material photo cards as the deactivation authentication factor based on a user input for inputting the deactivation identification code.

In addition, in an embodiment, the application 111 may acquire the photo card deactivation authentication factor for the plurality of material photo cards based on a user input providing a disposal video for the plurality of material photo cards.

In detail, in an embodiment, the application 111 may acquire a user input to capture a disposal video as described above and register the same on the platform.

In addition, the application 111 may perform image analysis on the acquired disposal videos to discriminate whether the plurality of material photo cards have been properly disposed.

In an embodiment, the application 111 may discriminate whether a physical photo card in the disposal video is a physical photo card for the plurality of material photo cards based on the card identification code frame in the disposal video.

In addition, when the plurality of material photo cards are determined as physical photo cards as a result of the discrimination, the application 111 may discriminate whether a disposing action has been performed on the plurality of material photo cards based on image analysis of the disposal videos.

For example, the application 111 may determine whether the material photo card in the disposal video has been incinerated or cut beyond a predetermined criterion through image analysis based on the disposal video.

In addition, when it is determined that the disposal action has been performed to meet a predetermined criterion, the application 111 may acquire the corresponding disposal image as the deactivation authentication factor.

In addition, in an embodiment, the application 111 may perform disposal processing for the plurality of material photo cards based on the acquired photo card deactivation authentication factor.

In detail, in an embodiment, when all photo card deactivation authentication factors for each of the plurality of material photo cards are acquired, the application 111 may perform the disposal processing to remove the plurality of material photo cards from an online platform.

In more detail, in an embodiment, the application 111 may detect a card identification code for each of a plurality of material photo cards for which the photo card deactivation authentication factor has been acquired.

In this connection, when the deactivation authentication factor is the deactivation identification code described above, the application 111 may extract the card identification code managed to match the deactivation identification code and perform the functional operation described above.

Alternatively, when the deactivation authentication factor is the disposal video described above, the application 111 may extract the card identification code based on the card identification code frame in the disposal video and perform the aforementioned functional operation.

In addition, in an embodiment, the application 111 may perform the disposal processing to delete a photo card image (in other words, a digital photo card) matching the card identification code detected as above from the corresponding user account and platform.

In addition, in an embodiment, when the disposal processing for the plurality of material photo cards is completed in the manner described above, the application 111 may provide a user (in other words, a purchaser) with an upper photo card acquired based on the plurality of material photo cards.

In detail, in an embodiment, the application 111 may provide the upper physical photo card according to an embodiment to a user through offline delivery.

In addition, in an embodiment, the application 111 may provide the photo card image of the upper photo card according to an embodiment (in other words, the upper digital photo card) to a user through online delivery.

According to an embodiment, the application 111 may provide a user with the upper physical photo card provided through the offline delivery by registering the same online by matching the same to a corresponding user account in accordance with the aforementioned owner authentication function.

As such, the application 111 provides users with upper photo cards acquired through the material photo cards after the disposal of the material photo cards used for the upgrade is authenticated, thereby supporting indiscriminate supply restriction and rarity maintenance of photo cards, while automating the disposal authentication for each material photo card, thereby minimizing the loss of having to check and authenticate each one individually.

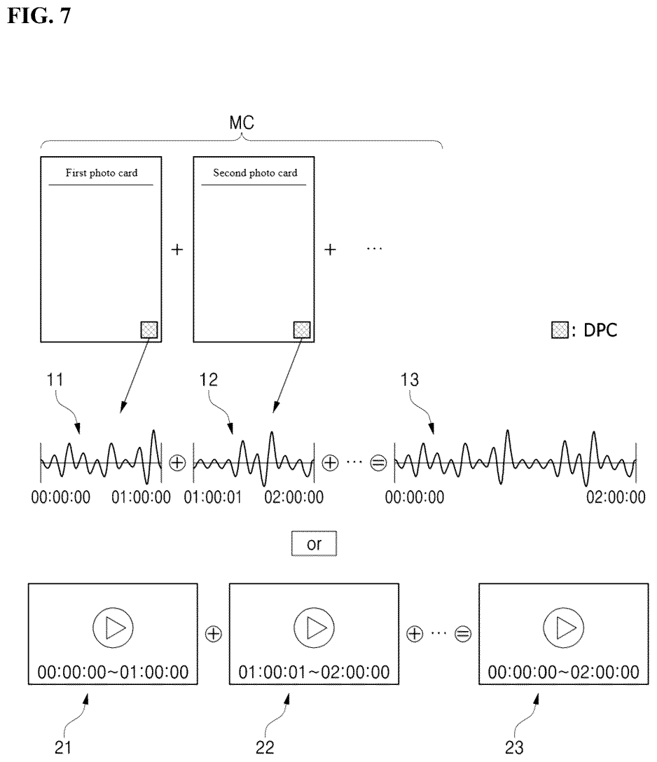

FIG. 7 is an example of a diagram illustrating a method for combining a plurality of pieces of photo card content according to an embodiment of the present disclosure.

Referring to FIG. 7, in an embodiment, when a combination according to the aforementioned criterion is successful, the application 111 may combine photo card content of plurality of material photo cards (MCs) used in the combination into one piece of content.

In detail, in an embodiment, the application 111 may combine photo card content provided from each of the plurality of material photo cards (MC) according to a predetermined criterion(for example, by identical or similar content) to create one piece of content (hereinafter, integrated content).

In an embodiment, when first photo card content of a first material photo card is first digital sound source content 11 and second photo card content of a second material photo card is second digital sound source content 12, the application 111 may create third digital sound source content 13 that combines the first digital sound source content 11 and the second digital sound source content 12 as integrated content.

In addition, in an embodiment, when first photo card content of the first material photo card is first digital video content 21 and second photo card content of the second material photo card is the second digital video content 22, the application 111 may create third digital video content 23 that combines the first digital video content 21 and the second digital video content 22 into integrated content

Thus, for example, when one digital sound source is divided into the first digital sound source content 11 and the second digital sound source content 12 and is assigned as the photo card content of each of the plurality of photo cards, the application 111 may combine the first digital sound source content 11 and the second digital sound source content 12 into one when the combination of the plurality of photo cards is successful, thereby acquiring a complete digital sound source (in other words, integrated content according to an embodiment).

As another example, when one single digital video (for example, a full concert video or a full music video) is divided into the first digital video content 21 and the second digital video content 22 and assigned as the photo card content of each of the plurality of photo cards, the application 111 may combine the first digital video content 21 and the second digital video content 22 into one when the combination of the plurality of photo cards is successful, thereby acquiring a complete digital video (in other words, integrated content according to an embodiment).

As such, the application 111 may provide the photo card content provided by each of the plurality of random photo cards as one piece of integrated content when the combination based on the plurality of random photo cards is successful according to a predetermined criterion, thereby providing a higher motivation for collecting random photo cards, and thereby further increasing the purchasing needs and desires of users (in other words, buyers) for random photo cards.

Hereinbefore, a method and system for providing an optional platform album-based service according to an embodiment of the present disclosure can prevent issues such as unnecessary payment and purchase of undesirable configurations by a user when a platform album is provided only in a full package state including all components by providing a service based on an optional platform album that can be purchased by selectively setting purchase options, thereby reducing wasteful resources or costs.

In addition, the method and system for providing the optional platform album-based service according to an embodiment of the present disclosure can provide a customized platform album including components directly selected according to the needs of a purchaser when purchasing an online-based platform album, thereby enabling a user to flexibly determine an album purchase cost according to the components selected to purchase, thereby preventing excessive spending due to unnecessary consumption and supporting the performance of a purchase procedure based on a more reasonably calculated album purchase cost.

In addition, the method and system for providing the optional platform album-based service according to an embodiment of the present disclosure support sales volume aggregation for the optional platform album purchased as described above based on a unique number and delivery code (invoice number) of the album, thereby enabling album ranking aggregation within a specific chart to be performed more accurately and reliably based on official and objective sales data collected over a larger area.

In addition, the method and system for providing the optional platform album-based service according to an embodiment of the present disclosure support sales of the purchased optional platform album to be easily reflected in the album sales volume aggregation for calculating album ranking within a specific chart based on the unique number and delivery code (invoice number) of the purchased optional platform album, thereby enabling smooth application of the album sales volume aggregation only with the purchase of at least one component of the optional platform album, and thus further improving the accuracy of calculating the album sales volume parameter value for determining a predetermined album ranking chart.

In addition, the method and system for providing the optional platform album-based service according to an embodiment of the present disclosure can enhance the interest and curiosity of purchasers regarding the optional platform album and further increase their desire to purchase by providing a purchase authentication code and/or a random photo card related to the purchased optional platform album and providing a customized management service based thereon.

The embodiments of the present disclosure described above may be implemented in the form of program instructions which may be executed through various types of computer constituting elements and recorded in a computer-readable recording medium. The computer-readable recording medium may include program instructions, data files, and data structures separately or in combination thereof. The program instructions recorded in the computer-readable recording medium may be those designed and configured specifically for the present disclosure or may be those commonly available for those skilled in the field of computer software. Examples of a computer-readable recoding medium may include magnetic media such as hard-disks, floppy disks, and magnetic tapes; optical media such as CD-ROMs and DVDs; and hardware devices specially designed to store and execute program instructions such as ROM, RAM, and flash memory. Examples of program instructions include not only machine codes such as those generated by a compiler but also high-level language codes which may be executed by a computer through an interpreter and the like. The hardware device may be replaced with by one or more software modules to perform the operations of the present disclosure, and vice versa.

### INDUSTRIAL APPLICABILITY

An embodiment of the present disclosure relates to a method for providing an optional platform album-related service, which is designed to purchase an album and provide various pieces of related digital content through the operation of a server and a terminal, and thus has industrial applicability.

1. A method for providing an optional platform album-based service, in which a platform application executed by at least one processor of a terminal provides an optional platform album-based service, the method comprising:
providing an optional platform album purchase interface;
determining included components of an optional platform album based on the provided purchase interface;
performing a payment process according to the determined included components;
performing a delivery process according to the determined included components; and
providing sales authentication information about the optional platform album based on a unique number of the optional platform album and a delivery code acquired based on the performed delivery process.

2. The method of claim 1, wherein the determination of the included components of the optional platform album comprises determining components to be included in the optional platform album based on a purchase option set according to a user input based on the purchase interface.

3. The method of claim 2, wherein the components comprises at least one of a predetermined CD, digital content, an album jacket, a pictorial, a photo card, or a special benefit.

4. The method of claim 3, wherein the determination of the included components of the optional platform album further comprises determining a customized offline configuration provided to a user offline and a customized online configuration provided to the user online.

5. The method of claim 4, wherein the determination of the included components of the optional platform album further comprises adding a purchase authentication code for at least one of the digital content or the photo card to the included components when the at least one of the digital content or the photo card is determined as the included components.

6. The method of claim 5, wherein the purchase authentication code comprises at least one of an offline authentication code provided to a user offline or an online authentication code provided to the user online.

7. The method of claim 4, wherein the determination of the included components of the optional platform album further comprises setting a randomly selected photo card from among a plurality of photo cards matching the optional platform album as the included components when the photo card is determined as the included components.

8. The method of claim 7, wherein the photo card comprises at least two of a predetermined image, a card identification code specifying the photo card, or a digital content provision code providing photo card content activated based on the photo card.

9. The method of claim 1, wherein the performance of the payment process according to the determined included components comprises determining a purchase cost of the optional platform album based on a price preset for each included component.

10. The method of claim 4, wherein the performance of the delivery process according to the determined included components comprises delivering the customized offline configuration to the user offline and delivering the customized online configuration to the user online.

11. The method of claim 1, wherein the provision of the sales authentication information about the optional platform album comprises reflecting the sales authentication information in an album sales volume aggregation for determining a predetermined album ranking chart.

12. The method of claim 8, further comprising providing a customized management service for each included component in the optional platform album that has been purchased based on performed payment process.

13. The method of claim 12, wherein the provision of the customized management service comprises performing a purchase authentication process based on at least one of an offline authentication code or an online authentication code of at least one of the digital content or the photo card when the included components in the optional platform album that has been purchased comprises at least one of the digital content or the photo card.

14. The method of claim 12, wherein the provision of the customized management service comprises providing at least one of an owner authentication function for matching and storing a random photo card provided to the user to a user account, a collecting function for managing a random photo card that has been matched and stored to the user account, or an upgrade function for combining at least some of a plurality of random photo cards owned by the user when the included components in the optional platform album that has been purchased comprise the photo card.

15. The method of claim 14, wherein the provision of the upgrade function comprises integrating photo card content for each of a plurality of material photo cards used in the combination into one piece of content.

16. A system for providing an optional platform album-based service, the system comprising:
at least one memory in which a platform application is stored; and
at least one processor for reading out the platform application stored in the memory and providing the optional platform album-based service;
wherein instructions of the platform application comprise instructions for:
providing an optional platform album purchase interface;
determining included components of an optional platform album based on the provided purchase interface;
performing a payment process according to the determined included components;
performing a delivery process according to the determined included components; and
providing sales authentication information about the optional platform album based on a unique number of the optional platform album and a delivery code acquired based on the performed delivery process.

17. The system of claim 16, wherein the instructions of the platform application further comprise instructions for reflecting the sales authentication information in an album sales volume aggregation for determining a predetermined album ranking chart.

18. The system of claim 16, wherein the instructions of the platform application further comprise instructions for providing a customized management service for each included component in the optional platform album that has been purchased based on the performed payment process.
